(19) United States
(12) Patent Application Publication
(10) Pub. No.: US 2011/0020489 A1
(43) Pub. Date: Jan. 27, 2011

(54) Method for forming and selling candles

(76) Inventor: Jeffrey Schitter, Denver, CO (US)

Correspondence Address: MARSH, FISCHMANN & BREYFOGLE LLP, 8055 East Tufts Avenue, Suite 450, Denver, CO, 80237, US

(21) Appl. No.: 12/797,516

(22) Filed: Jun. 9, 2010

Related U.S. Application Data
(62) Division of application No. 12/042,506, filed on Mar. 5, 2008, now abandoned.
(60) Provisional application No. 60/893,271, filed on Mar. 6, 2007.

(51) Int. Cl. C11C 5/02; B29C 39/02

(52) U.S. Cl. 425/447

(57) ABSTRACT

A method and apparatus (“utility”) for quickly and conveniently melting and blending candle materials to form a candle is provided. The utility utilizes a heated inclined surface on which the candle materials may be placed to melt. The melted candle materials may be directed into a candle mold. The utility includes a drip spout for directing the candle materials into a candle mold. A method for providing consumers with the opportunity to make individualized candles is also provided. The method includes enticing consumers to make their own candles, as well as providing an apparatus and/or materials to make candles. The apparatus and candle materials may be purchased and/or rented by consumers.

### CROSS-REFERENCE TO RELATED APPLICATION

This application is a divisional of U.S. application Ser. No. 12/042,506 having a filing date of Mar. 5, 200 and which claims priority under 35 U.S.C. 119 to U.S. Provisional Application No. 60/893,271, entitled, “METHOD FOR FORMING AND SELLING CANDLES,” filed on Mar. 6, 2007, the contents of both of which are incorporated herein as if set forth in full.

### FIELD

The present invention relates generally to candles and more specifically to a method and apparatus for making candles and method for marketing and selling individualized candles.

### BACKGROUND

Candles are used as sources of light and often as attractive ornaments. Such candles are typically made from solidified wax or wax-like compositions. For instance, opaque candles may be made from paraffin or stearic acid. Often, a mixture of paraffin and stearic acid is used.

Because candles are also used as decorative ornaments, processes for enhancing their appearance have been developed. For instance, colorants and dyes are often mixed into the structure of candles to provide a candle having a desired color. Further, it is common to decorate the outside surfaces of larger candles. For example, it is known to screen print on candles to provide a pattern or picture on an outside surface thereof. Candles may also have multiple colored layers to provide a decorative effect. For instance, a plurality of wax pieces may be shaped and stacked and/or melted together to form a decorative candle body.

In addition to colorants and dyes, various items may be placed within the structure of candles. For instance, oils and/or scents/perfumes may be disposed within the structure of a candle such that the candle provides an aromatic smell when utilized. Further, objects may be placed within the structure of the candle such that those objects become visible as the candle melts, are visible through at least partially translucent structures of the candle, and/or extend through edge surfaces of the candle.

While many types of ornate candles are produced today, such candles are typically pre-made. That is, consumers do not have the ability to individualize an ornamental candle to their own liking.

### SUMMARY

In order to allow for individualized candle making, provided herein is an apparatus that may be utilized to quickly and conveniently melt candle materials such as paraffin, stearic acid, natural wax, etc. (hereinafter wax). Generally, the apparatus utilizes a heated inclined surface on which wax may be placed to melt. This allows for surface melting of wax, which reduces or eliminates the need to melt a reservoir of wax. Accordingly, small amounts of wax may be melted on the inclined surface and the melted wax may be directed into a candle mold. Other material may be mixed with the wax and/or different colors of wax may be mixed on the surface of the apparatus.

To provide for easier use and functionality, the slope of the heated inclined surface may be selectively adjustable by a user. For instance, it may be desirable to position the surface at a level slope when melting and/or blending the candle materials, and to position the surface at an inclined slope such that the melted materials may be poured into a candle mold. Additionally, the height of the apparatus may be selectively adjustable. In this regard, it may be desirable to adjust the height of the apparatus to accommodate users of different height. Additionally or alternatively, the height of the apparatus may be adjusted, for example, such that the apparatus may be positioned on a table or a floor.

To provide a means for directing the melted candle materials into a candle mold, the apparatus may further include a drip spout. The drip spout may be any mechanism that is suitable to channel the materials from the heated surface into a candle mold. For example, in one embodiment, the drip spout is formed by first and second lips disposed on adjacent edges of the heated surface.

The apparatus or more traditional candle making apparatuses (e.g., reservoir type candle makers) may be utilized in one or more methods. For instance, consumers may be enticed to make their own candles in, for example, a retail setting. In such a situation, the consumer may rent time on the apparatus and have access to candle making materials. Alternatively, the apparatuses may be provided and consumers may select and purchase candle making goods that are provided for purchase. Alternatively, the apparatus may be provided in a kit with, for example, a predetermined amount of candle making goods. Consumers may then purchase additional materials.

### BRIEF DESCRIPTION OF THE DRAWINGS

FIG. 1 illustrates a plan front view of one embodiment of an apparatus in accordance with the present invention.

FIG. 2. illustrates a plan side view of the apparatus of FIG. 1.

FIG. 3 illustrates a process flow sheet.

### DETAILED DESCRIPTION

Provided herein is an apparatus that allows an individual to melt and mold wax or wax-like materials (hereafter wax) in order to form a candle. In conjunction with such melting and molding, the individual may be allowed to mix various different types of waxes (e.g., having different colors) and/or add objects into the wax to provide desired characteristics to the resulting candle. In addition, a method for marketing such candles is provided. For instance, such marketing may include providing locations where consumers may be enticed to form their own individual candles in, for example, a retail setting.

Reference will now be made to the accompanying drawings, which assist in illustrating the various pertinent features of the candle-making apparatus and methods. The following description is presented for the purposes of illustration and inscription and is not intended to limit the invention to the form disclosed herein. Consequently, variations and modifications consummate with the following teachings, in skill and knowledge of the relevant art, are within the scope of the present disclosure.

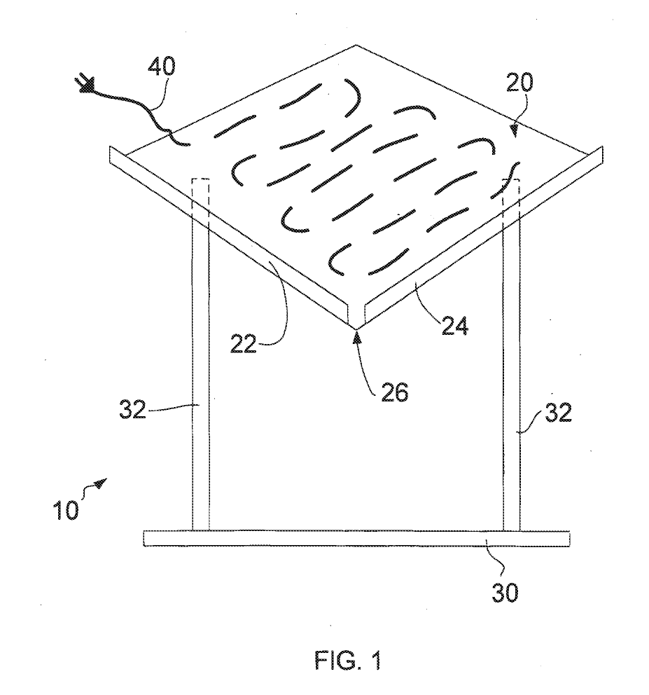

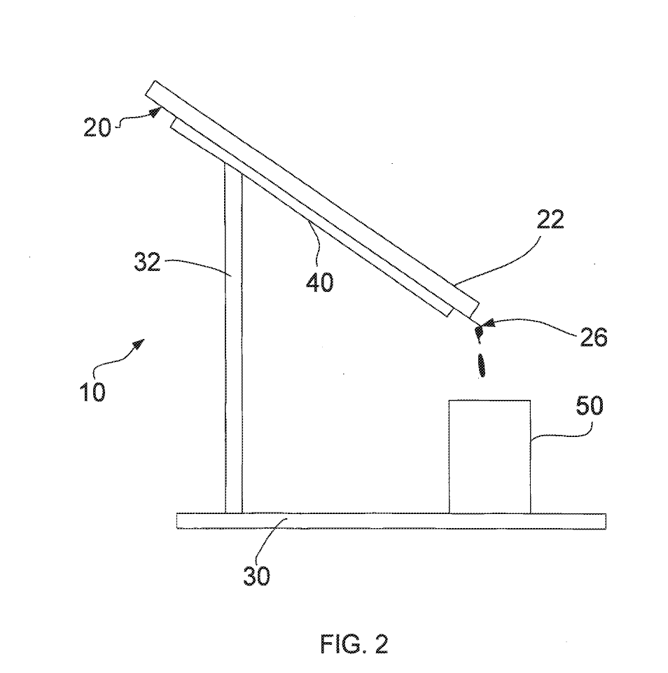

FIGS. 1 and 2 show front and side views, respectively, of a candle making apparatus 10. The candle making apparatus 10 utilizes a heated surface to melt wax, which may drip from the heated surface into a candle mold 50.

As shown, the apparatus 10 includes an elevated plate 20. The elevated plate 20 is suspended above the base member 30 by one or more support members 32. The elevated plate 20 is disposed at an angle relative to the base member 30. The plate member 20 further includes a heater element 40 that is operative to heat the plate member 20 (e.g., via conductive, radiative and/or convective contact). Any heating element may be utilized, and the heating element may be thermostat or rheostat controlled. Further, a control mechanism may be included to manage the rate at which the candle materials melt. In this regard, the heating element may be controlled to melt different materials at different temperatures. What is important is that the heating element 40 is operative to apply heat to the plate member 20. As shown, the heating element 40 is thermally connected to a bottom surface of the elevated plate number 20.

The plate member 20 is formed from a conductive material such as steel or aluminum. Accordingly, heat applied to the plate member 20 (e.g., through its bottom surface) is conducted to top surface of the plate number 20. Wax for use in forming a candle may be set on top of the plate member 20 where the heat from the heating element causes the wax to melt. Do the slope of the elevated plate member 20, the melted wax runs down the top surface of the elevated plate member 20 to a drip spout 26. As shown, the plate member 20 includes first and second lips 22, 24 that are disposed along the lower forward edges of the plate member 20. These lips 22, 24 channel melted wax towards the drip spout 26. Accordingly, the melted wax drips from the drip spout 26 into a candle mold 50. It will be appreciated that the first and second lips 22, 24 in addition to channeling wax towards the drip spout may also be utilized to restrain unmelted wax (e.g., blocks of wax) on the surface of the plate member 20, for instance, when such materials are melting.

The present arrangement provides a number of benefits over existing candle making apparatuses. For instance, prior apparatuses for making candles typically utilize a reservoir in which a predetermined amount of wax is melted. Once the wax in the reservoir is melted, a spigot or other valve may be opened to allow the wax to pour into a candle mold. While effective for filling a candle mold with wax, previous apparatuses for making candles do not permit the rapid change of wax types/colors. In contrast, the surface melting system described herein permits small amounts of candle making materials (e.g., wax, dyes, perfumes, etc.) to be melted and/or blended on the surface of the plate member 20. For instance, a first set of materials (e.g., wax shavings of a first color) may be melted on the surface of the plate and a second set of materials may be subsequently melted and/or intermixed with the first color shavings. Accordingly, a user is able to freely design the characteristics of their candle.

It will be appreciated that variations may be made to the apparatus of FIGS. 1 and 2. For instance, the plate number 20 may be pivotally attached to the support members 32. In such an arrangement, the angle of the plate member may be selected by a user. This may allow a user to displace the plate between, for example, a horizontal position to a steeply angled position. In this regard, a user may be allowed to place the plate in a substantially horizontal position in order to maintain melted wax on the surface of the plate member 20 in order to better mix, for example, different waxes and/or objects within the wax.

In a further arrangement, a melt pan (not shown) may be disposed on the surface of the plate member 20. Such a melt pan may be restrained on the surface of the plate member 20 by the first and second lips 22, 24. Such a melt pan may be formed of a conductive material such as steel or aluminum. The melt pan may enhance the ability to blend materials with wax melted within the pan. Accordingly, once the desired materials are mixed within melted wax disposed within such a melt pan, the wax may be poured directly into the mold 50 or poured onto the surface of the plate member 20 such that it may drip into the mold 50 from the drip spout 26. Alternatively, a stop plug may be provided for disposition between the lips 22, 24 that is operable to inhibit the passage of candle materials from the inclined surface of the plate member. For example the stop plug may be configured to prevent candle materials from passing through the drip spout 26. Additionally, the apparatus may include a screen to filter out candle materials that are greater in size than the holes in the screen. In a further arrangement, the support member 32 may be adjustable in height such that the height of the drip spout 26 may be adjusted to accommodate differently sized molds 50.

Though illustrated as utilizing a flat plate having first and second lips for directing melted wax, it will be appreciated that many variations of the candle making apparatus are envisioned. What is important is that a surface melting system is provided allows for channeling melted wax into a mold. In this regard, the use of surface melting allows for rapid changing of candle components. That is, as opposed to previous candle making systems that utilize a reservoir of melted wax and a spigot, the present apparatus allows for surface melting of small or large amounts of wax.

The wax/wax-like material utilized to form the candle may be any appropriate material, including natural and synthetic materials. Non-limiting examples of such materials include beeswax, paraffin, soy wax, and palm wax. Further, it will be appreciated that these wax-like materials may be in any form. For instance, these materials may be in block form such that they may be set on the plate member 20. Alternatively, pellets, shavings, powders, and even liquid forms of material may be utilized. Accordingly, such wax-like materials, in any form, may be uncolored or colored. For uncolored materials, it will be appreciated that coloring additive may be included such that a user may mix the colorant with the melting wax. A non-inclusive list of objects that may be mixed with the melted wax material includes scents, perfumes, oils, stearic acid, candle dyes (in any form), and/or vybar.

A second aspect is direct to a method of use of the candle making apparatus 10. Generally, a method is provided where the apparatus and various candle making materials may be provided to a user. A user of the apparatus 10 may then select (e.g., purchase) different candle making materials. The user may then selectively melt, mix and/or blend these materials on the plate member 20 and hence permit and direct their distribution into a candle mold 50. Accordingly, the user may alternate different materials and or add additional materials (e.g., rose petals, perfumes, etc) directly to the surface of the plate 20 and/or into the mold 50. Accordingly, the apparatus allows for a method wherein a candle making apparatuses is provided and candle contents are sold to users who may then form their own personalized/individualized candles utilizing materials purchased from the vendor.

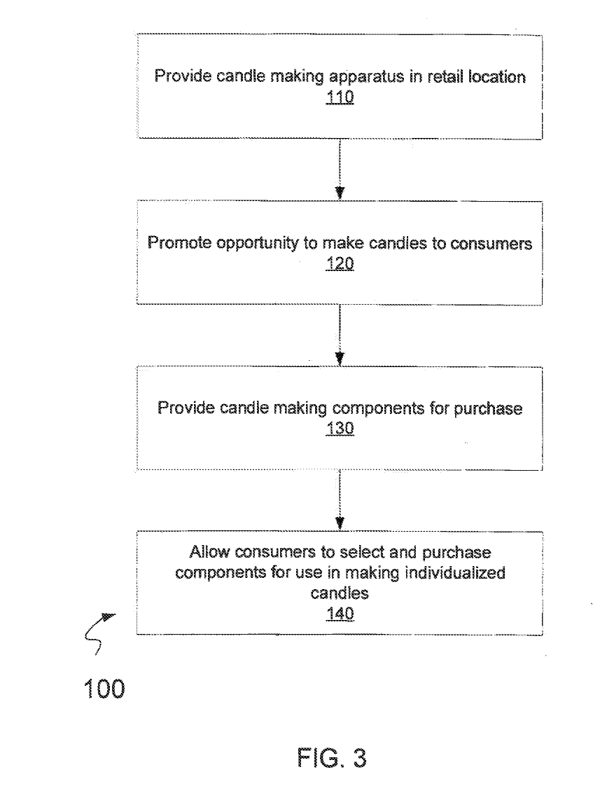

FIG. 3 illustrates one embodiment of such a method 100 where the candle-making apparatus or apparatuses may be provided (110) in a location (e.g., in a retail setting) to entice users/consumers to form and purchase an individualized candle. For instance, such a location may be a kiosk at a mall and/or a festival or fair setting, and/or any retail setting whether part of a larger operation or intended solely for this business. In this regard, a number of sample candles may be displayed, and the opportunity to form a candle may be presented (120) to consumers. That is, consumers may be invited to utilize the apparatus or apparatuses to form their individual candles. Accordingly, candle-making components may be purchased (130), and consumers may have the opportunity to select and purchase (140) individual components for their candle, including, without limitation, waxes and/or objects to be disposed within the wax. Alternatively, consumers may purchase the opportunity to form a single candle and, in conjunction with such, purchase the allowed, utilized any materials supplied by the retail outlet. In this latter regard, the consumer may be effectively renting the opportunity to utilize the apparatus to form, for example, a single candle.

In a further embodiment, individual candle-making apparatuses may be sold to consumers. In such an embodiment, consumers may have the opportunity to buy prepackaged candle-making materials. Alternatively, the apparatus and materials to make a predetermined number of candles may be provided in a kit. Accordingly, consumers may then have the opportunity to purchase replacement candle-making components for use with their apparatus.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. An apparatus for making candles comprising:
a base member;
an inclined surface that is adapted to receive one or more candle-making materials; wherein the inclined surface comprises a plate member that substantially resides in a single plane;
a heating element coupled to said inclined surface, wherein said heating element is operable to heat said inclined surface to melt at least one of said one or more candle-making materials; and
a support member coupled to said inclined surface and adapted to support said inclined surface at a slope relative to the base member;
wherein a lower portion of said inclined surface includes a dripping mechanism for channeling said one or more candle-making materials into a candle mold; wherein the dripping mechanism comprises first and second lips disposed on adjacent edges of the inclined surface and a drip spout located between the first and second lips; wherein the first and second lips converge towards the drip spout.

2. (canceled)

3. The apparatus of claim 1, wherein the slope of said inclined surface is selectively adjustable.

4. The apparatus of claim 1, wherein the height of said apparatus is selectively adjustable.

5. The apparatus of claim 1, wherein said heating element is operable to heat said inclined surface at a plurality of temperatures.

6. The apparatus of claim 1, wherein said one or more candle-making materials comprise at least one of wax, paraffin, dye, perfume, oil, and stearic acid.

7-21. (canceled)
